(19) United States
(12) Patent Application Publication
(10) Pub. No.: US 2002/0080695 A1
(43) Pub. Date: Jun. 27, 2002

(54) Recording apparatus for information recording medium and recording method

(76) Inventors: Noriaki Horii, Osaka (JP); Masaya Yamamoto, Osaka (JP); Masatoshi Shimbo, Hyogo (JP)

Correspondence Address: Neil A. DuChez, Renner, Otto, Boisselle, & Sklar, L.L.P., 19th Floor, 1621 Euclid Avenue, Cleveland, OH, 44115, US

(21) Appl. No.: 10/000,852

(22) Filed: Oct. 23, 2001

(30) Foreign Application Priority Data
Oct. 27, 2000 (JP) 2000-328554

(51) Int. Cl. G11B 7/0045

(52) U.S. Cl. 369/47.16; 369/59.27

(57) ABSTRACT

There is provided a recording apparatus for recording first audio information including a first audio content in an information recording medium which can store a plurality of audio contents having a plurality of different audio properties, the Information recording medium containing second audio information including a second audio content, wherein the recording apparatus includes: a conversion section for converting an audio property of soundless information of the first audio information into the same audio property as the audio property of the second audio information; and a recording section for recording the soundless information in the information recording medium as a part of the second audio information so as to be adjacent to a tail of the second audio content, and recording the first audio content in the information recording medium.

### BACKGROUND OF THE INVENTION

1. Field of the Invention

The present Invention relates to a recording apparatus for recording a plurality of audio information which have different audio properties on a rewritable information recording medium or a write once type information recording medium.

2. Description of the Related Art

Conventionally, in a compact disc (CD), soundless information of several seconds is stored in “Index 0” which indicates an interval between songs that is provided at the head of each song. However, in the specifications of minidisks (MDs), such “Index 0” is not defined as a specification.

Copying of songs from a CD into a MD is described with reference to FIGS. 1 and 2. Herein, a “song” means audio information including at least an audio content. Preferably, a “song” is audio information which includes an audio content and intermission information adjacent to the head or tail of the audio content. The intermission information represents an interval between songs and is usually included in Index 0.

When copying songs from a CD into a MD, a user selects a song that he/she desires to copy into a MD (in FIG. 1, a song 12 and a song 13) by using a remote controller or the like. Next, the user directs with a remote controller or the like a recording apparatus to start copying the song 12 and the song 13. In many recording apparatuses, in response to such a direction, an optical pickup moves such that laser light is incident on the end of Index 0 included in the song 12, and then, reading of audio information of the song 12 and the song 13 is started. In this case, as shown in FIG. 2, intermission information included in Index 0 of the song 12 is not read out whereas an audio content 14 of the song 12 and Index 0 and an audio content 15 of the song 13 are read out from the CD so as to be recorded on the MD. As shown in FIG. 2, in many information apparatuses, intermission information included in Index 0 of the song 13 is copied at the end of a song 21 as a part thereof. Thus, when copying songs from a CD into a MD, in many cases, soundless information included in Index 0 of a song is copied as a part of a previous song at the tail of the previous song.

In the DVD-Audio specifications established as application specifications of digital versatile discs (DVDs), recording of audio contents having various audio properties is allowed. For example, sampling frequencies of 44.1 kHz, 48 kHz, 88.2 kHz, 96 kHz, 176.4 kHz, and 192 kHz, and quantization bits of length 16 bits, 20 bits, and 24 bits are supported by the DVD-Audio specifications. Thus, according to the DVD-Audio speacfications, a plurality of songs having different audio properties can be recorded in a single recording medium. Also in the DVD-Audio specifications, as in a CD, soundless information which indicates an interval between songs can be stored in Index 0.

As high-density rewritable or write once type information recording medium, a DVD-R disc, a DVD-RAM disc, and a DVD-RW disc have been developed. Audio contents based on the DVD-Audio specifications can be recorded on a DVD-R disc, a DVD-RAM disc, and a DVD-RW disc for the purpose of making a backup copy, or any other like purpose.

A typical example of recording of audio contents into a rewritable or write once type information recording medium is a copying of audio contents from a packaged medium, such as a DVD-Audio disc, a CD, etc. Problems involved in copying of audio contents from a DVD-Audio disc or a CD into an information recording medium and problems involved in reproduction of audio contents recorded in an information recording medium are described.

In the first place, copying and reproducing of audio contents from a DVD-Audio disc are described. Referring to FIG. 3, copying of an audio content 36 and an audio content 37 from a DVD-Audio disc into an information recording medium 55 by using the same method as that used for copying songs from a CD into a MD is described. Under the DVD-Audio specifications, a plurality of songs having different audio properties may be mixedly stored in a single DVD-Audio disc. In the example shown in FIG. 3, the DVD-Audio disc sequentially stores a song 31, a song 32, and a song 33, which have different audio properties from one another. When the song 32 and the song 33 are copied from the DVD-Audio disc to the information recording medium 55 by using the same method as that used for copying songs from a CD into a MD, intermission information included in Index 0 of the song 33 is copied as a part of a song 34 at the tail thereof. In this case, the sampling frequency of the audio content 36 of the song 34 is 96 kHz while the sampling frequency of the intermission information 38 copied at the tail of the song 34 is 48 kHz. Thus, the song 34 mixedly includes a plurality of information of different audio properties. When reproducing the song 34 containing such information, it is necessary to change reproduction conditions of the reproduction apparatus according to the change of audio properties at a transition point from the audio content 36 to the intermission information 38. Some reproduction apparatuses cannot follow the change of audio properties so that a mute period or noise is caused during the reproduction of the song 34. Alternatively, when reproduction is started with a song 35 after a searching operation, an optical pickup of the reproduction apparatus moves so as to read information from the head of the song 35. In this case, if the audio properties of the song 35 are different from those of a song reproduced immediately before the reproduction of the song 35, the reproduction apparatus needs to change its reproduction conditions such that the song 35 can be appropriately reproduced. In this case also, if the reproduction apparatus cannot appropriately change the reproduction conditions according to the change of audio properties, a mute period or noise is caused during the reproduction of the song 35, so that a beginning portion of the song 35 cannot be appropriately reproduced.

Index 0 of the DVD-Audio disc is also information which indicates the presence of an interval between songs. Thus, when copying songs from the DVD-Audio disc to the information recording medium 55, it is desirable to record information indicating an interval between songs at the head of each of the copied songs.

According to a recording method, when copying songs from the DVD-Audio disc to the information recording medium 55, in response to the start of reproduction of a song, a recording apparatus automatically starts recording audio information read from the DVD-Audio disc by the reproduction apparatus. When this recording method is used, in many reproduction apparatuses, an optical pickup is moved to reproduce a selected song such that laser light is incident on the end of Index 0 of the selected song. Thus, intermission information included in Index 0 of the selected song is not copied into the information recording medium 55.

Copying of a song 42 and a song 44 recorded on a DVD-Audio disc into an information recording medium 55 is described with reference to FIG. 4. In the first place, a reproduction apparatus moves its optical pickup such that laser light is incident on the end of Index 0 of the song 42 so as to read an audio content 47 of the song 42. The read audio content 47 is recorded on the information recording medium 55. After reading of the song 42 is completed, the reproduction apparatus moves the optical pickup such that the laser light is incident on the end of Index 0 of the song 44 so as to read an audio content 48 of the song 44. Similarly, the read audio content 48 is recorded on the information recording medium 55. In the example illustrated in FIG. 4, the audio properties of a song 45 are different from those of a song 46. Thus, in order to sequentially reproduce the song 45 and the song 46, the reproduction apparatus needs to change its reproduction conditions at the transition point from the song 45 to the song 46 so as to conform to the audio properties of the song 46. In this case, if the reproduction apparatus cannot appropriately change the reproduction conditions according to the change of audio properties, a mute period or noise is caused at a beginning portion of the song 46, so that the beginning portion of the song 46 cannot be appropriately reproduced. In addition, intermission information (soundless information) included in Index 0 of the DVD-Audio disc is not copied into the information recording medium 55. That is, information indicating the presence of an interval of songs is lost in the process of copying.

Next, copying of songs from a CD to an information recording medium and reproduction of the copied songs are described. In a CD, the audio properties are always the same for all of the songs recorded therein. Thus, when the songs are copied from the CD to the information recording medium without changing their audio properties, different properties never mixedly exist in a single copied song or in the information recording medium. However, if the audio properties of a song to be copied into the information recording medium are changed by using a compressed coding method for long-time recording, songs having different audio properties may be recorded in one information recording medium. If such a recording medium does not have intermission information between songs, when a reproduction apparatus needs to change its reproduction condition so as to conform to the audio properties of a song to be reproduced, for example, when a plurality of songs are serially reproduced, or when reproduction is started with a selected and searched song, a mute period or noise is caused at a beginning portion of the reproduced song in some reproduction apparatuses. Moreover, information indicating the presence of an interval of songs is lost in the process of copying.

When songs are copied from a CD to an information recording medium by using the same method as that used for copying songs from a CD into a MD, intermission information (soundless information) included in Index 0 of a song stored in the CD is copied into the information recording medium as a part of a previous song at the tail of the previous song. Thus, even when songs are copied from a CD to an information recording medium, the same problems as those described above as for copying of information from a DVD-Audio disc to an information recording medium and reproduction of the copied information occur.

### SUMMARY OF THE INVENTION

According to one aspect of the present invention, there is provided a recording apparatus for recording a first audio content in an information recording medium which can store a plurality of audio contents having a plurality of different audio properties, the first audio content being included in first audio information together with soundless information adjacent to a head of the first audio content, and the information recording medium containing second audio information including a second audio content, wherein the a recording apparatus includes: a detecting section for detecting audio properties of the first audio information and determining whether or not the detected audio properties of the first audio information are identical to audio properties of the second audio information; a conversion section for converting audio properties of the soundless information into the same audio properties as the audio properties of the second audio information when the detected audio properties of the first audio information are not identical to the audio properties of the second audio information; and a recording section for recording the soundless information In the information recording medium as a part of the second audio information so as to be adjacent to a tail of the second audio content, and recording the first audio content in the information recording medium.

In one embodiment of the present invention, the recording apparatus further includes a memory buffer for storing at least a portion of the first audio content.

In another embodiment of the present invention, the audio properties Include at least one of a sampling frequency, a number of quantization bits, a number of channels, and a coding method.

In still another embodiment of the present invention, the information recording medium is a rewritable or write once type information recording medium.

According to another aspect of the present invention, there is provided a recording apparatus for recording an audio content in an information recording medium which can store a plurality of audio contents having a plurality of different audio properties, wherein the recording apparatus includes: a detecting section for detecting audio properties of the audio content; a memory buffer for storing at least a portion of the audio content; a generating section for generating intermission information having the same audio properties as the detected audio properties of the audio content; and a recording section for recording the intermission information in the information recording medium as a part of audio information, and recording the audio content in the information recording medium as another part of the audio information so as to be adjacent to the tail of the intermission information.

In one embodiment of the present invention, the intermission information is soundless information.

In another embodiment of the present invention, the audio properties include at least one of a sampling frequency, a number of quantization bits, a number of channels, and a coding method.

In still another embodiment of the present invention, the information recording medium is a rewritable or write once type information recording medium.

According to still another aspect of the present invention, there is provided a recording apparatus for recording a first audio content immediately after second audio information including a second audio content in an information recording medium which can store a plurality of audio contents having a plurality of different audio properties, wherein the recording apparatus includes: a detecting section for detecting audio properties of the second audio information; a generating section for generating intermission information having the same audio properties as the detected audio properties of the second audio information; and a recording section for recording the intermission information in the information recording medium as a part of the second audio information so as to be adjacent to a tail of the second audio content, and recording the first audio content in the information recording medium.

In one embodiment of the present invention, the intermission information is soundless information.

In another embodiment of the present invention, the recording apparatus further includes a memory buffer for storing at least a portion of the first audio content.

In still another embodiment of the present invention, the audio properties include at least one of a sampling frequency, a number of quantization bits, a number of channels, and a coding method.

In still another embodiment of the present invention, the information recording medium is a rewritable or write once type information recording medium.

According to still another aspect of the present invention, there is provided a recording method for recording a first audio content in an information recording medium which can store a plurality of audio contents having a plurality of different audio properties, the first audio content being included in first audio information together with soundless information adjacent to a head of the first audio content, and the information recording medium containing second audio information including a second audio content, wherein the recording method includes steps of: detecting audio properties of the first audio information and determining whether or not the detected audio properties of the first audio information are identical to audio properties of the second audio information converting audio properties of the soundless information into the same audio properties as the audio properties of the second audio information when the detected audio properties of the first audio information are not identical to the audio properties of the second audio information; and recording the soundless information in the information recording medium as a part of the second audio information so as to be adjacent to a tail of the second audio content, and recording the first audio content in the information recording medium.

In one embodiment of the present invention, the recording method further includes a step of storing at least a portion of the first audio content.

In another embodiment of the present invention, the audio properties:include at least one of a sampling frequency, a number of quantization bits, a number of channels, and a coding method.

In still another embodiment of the present invention, the information recording medium is a rewritable or write once type information recording medium.

According to still another aspect of the present invention, there is provided a recording method for recording an audio content in an information recording medium which can store a plurality of audio contents having a plurality of different audio properties, wherein the recording method includes steps of: detecting audio properties of the audio content; storing at least a portion of the audio content; generating intermission information having the same audio properties as the detected audio properties of the audio content; and recording the intermission information in the information recording medium as a part of audio information, and recording the audio content in the information recording medium as another part of the audio information so as to be adjacent to the tail of the intermission information.

In one embodiment of the present invention, the intermission information is soundless information.

In another embodiment of the present invention, the audio properties include at least one of a sampling frequency, a number of quantization bits, a number of channels, and a coding method.

In still another embodiment of the present invention, the information recording medium is a rewritable or write once type information recording medium.

According to still another aspect of the present invention, there is provided a recording method for recording a first audio content immediately after second audio information including a second audio content in an information recording medium which can store a plurality of audio contents having a plurality of different audio properties, wherein the recording method includes steps of: detecting audio properties of the second audio information generating intermission information having the same audio properties as the detected audio properties of the second audio information: and recording the intermission information in the information recording medium as a part of the second audio information so as to be adjacent to a tail of the second audio content, and recording the first audio content in the information recording medium.

In one embodiment of the present invention, the intermission information is soundless information.

In another embodiment of the present invention, the recording method further includes a step of storing at least a portion of the first audio content.

In still another embodiment of the present invention, the audio properties include at least one of a sampling frequency, a number of quantization bits, a number of channels, and a coding method.

In still another embodiment of the present invention, the information recording medium is a rewritable or write once type information recording medium.

In order to solve the above-described problems involved in the conventional techniques, a recording apparatus of the present invention includes: an audio property converter; an audio property detecting section; a memory buffer; and an intermission information generator. In the recording apparatus of the present invention, the audio property converter changes, if necessary, audio properties of intermission information before the intermission information is recorded in an information recording medium. Alternatively, the intermission information generator generates intermission information for insertion into the head or tail of a song.

According to a recording method of the present invention, audio properties of soundless information stored in a source information recording medium (which is a source of songs to be copied) are changed if necessary, and then, the soundless information with changed audio properties is recorded in another information recording medium (destination medium). When soundless information stored in the source information recording medium cannot be utilized, intermission information is newly generated for insertion into the head or tail of a song.

Thus, the invention described herein makes possible the advantages of: (1) providing a recording apparatus and a recording method for recording intermission information in an information recording medium so as to secure a time for a reproduction apparatus to change its reproduction conditions so as to conform to the audio properties of a song to be reproduced; (2) providing a recording apparatus and a recording method for generating intermission information based on intermission information included in an original song and recording the generated intermission information in an information recording medium with a copied song.

These and other advantages of the present invention will become apparent to those skilled in the art upon reading and understanding the following detailed description with reference to the accompanying figures.

### BRIEF DESCRIPTION OF THE DRAWINGS

FIG. 1 shows a transition of laser light emitted by an optical pickup.

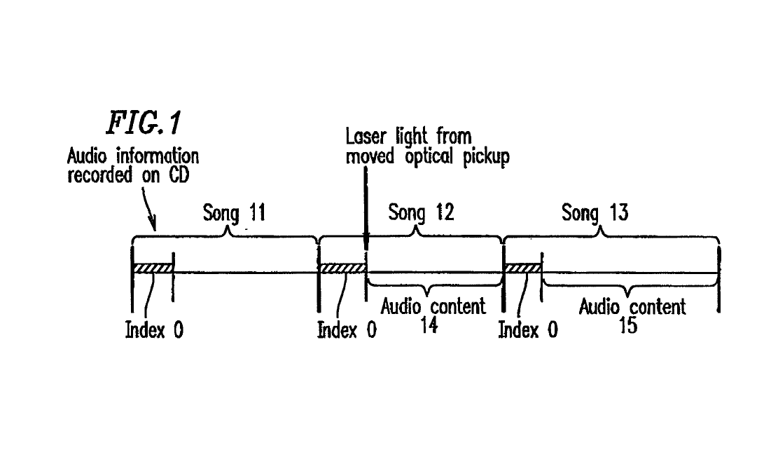

FIG. 2 illustrates copying of audio information from a CD to a MD.

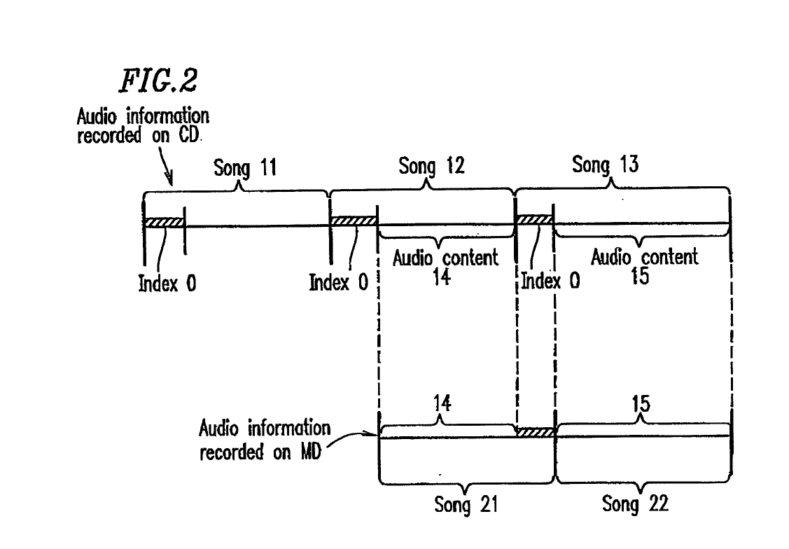

FIG. 3 Illustrates copying of a series of songs from a DVD-Audio disc to an information recording medium.

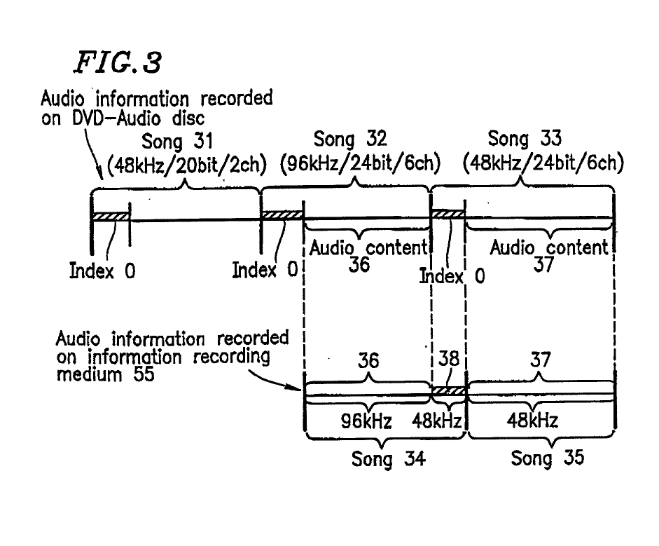

FIG. 4 illustrates copying of randomly-selected songs from a DVD-Audio disc to an information recording medium.

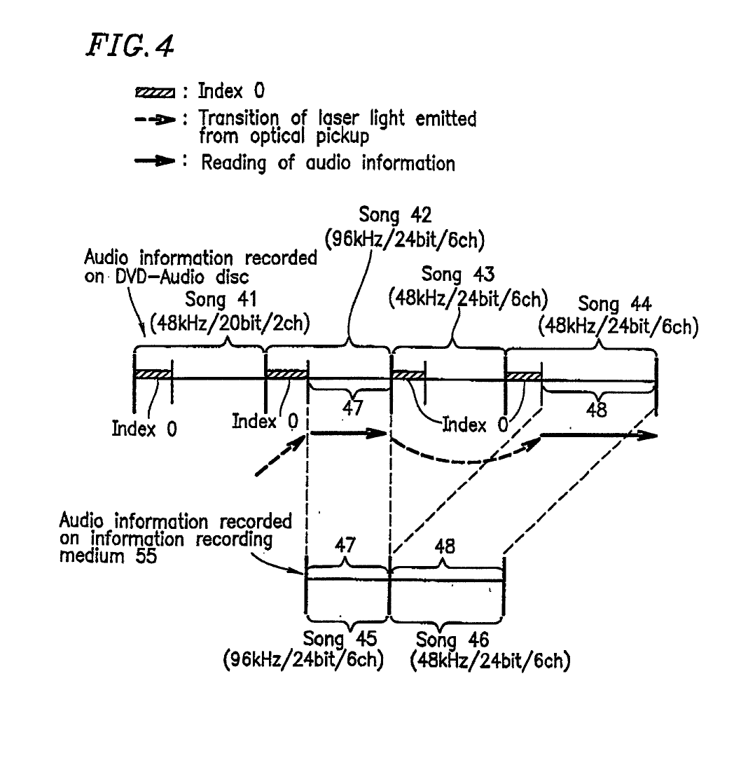

FIG. 5 shows a recording apparatus according to embodiment 1 of the present invention.

FIG. 6A illustrates copying of a plurality of songs having different audio properties according to embodiment 1 of the present invention.

FIG. 6B is a flowchart illustrating recording of songs according to embodiment 1 of the present invention.

FIG. 7 illustrates recording of a plurality of songs having different audio properties according to embodiment 1 of the present invention.

FIG. 8 shows a logical structure of a disc according to the present invention.

FIG. 9 shows a logical structure of pointer information according to the present invention.

FIG. 10 shows a recording apparatus according to the present invention.

FIG. 11A illustrates an example of copying of selected songs according to embodiment 2 of the present invention.

FIG. 11B is a flowchart illustrating recording of selected songs according to embodiment 2 of the present invention.

FIG. 11C illustrates another example of copying of selected songs according to embodiment 2 of the present invention.

FIG. 11D is a flowchart illustrating recording of selected songs according to embodiment 2 of the present invention.

FIG. 12A illustrates an example of copying of songs having no soundless information according to embodiment 2 of the present invention.

FIG. 12B illustrates another example of copying of songs having no soundless information according to embodiment 2 of the present invention.

### DESCRIPTION OF THE PREFERRED EMBODIMENTS

Hereinafter, embodiments of the present invention will be described with reference to the drawings. In this specification, a “song” is defined as audio information including at least an audio content. Preferably, a “song” is audio information which includes an audio content and intermission information adjacent to the head or tail of the audio content. “Intermission information” is defined as information provided between contents or songs which represents an interval between contents or songs.

Furthermore, a “song” may mean audio information included in a segment which is logically edited as one track based on a disc specification.

An “audio content” is information included in audio information recorded as a song except for intermission information. The audio content includes information of music to be reproduced, etc. “Audio properties” is defined as conditions based on which audio information on is structured. For example, the audio properties include at least one of a sampling frequency, a number of quantization bits, a number of channels, and a digital recording method for recording audio information (linear PCM, compression method, or the like). In the embodiments described below, audio information is recorded as songs. However, according to the present invention, the audio information is not limited to music information but may include information of sound, such as voice or the like.

(Embodiment 1)

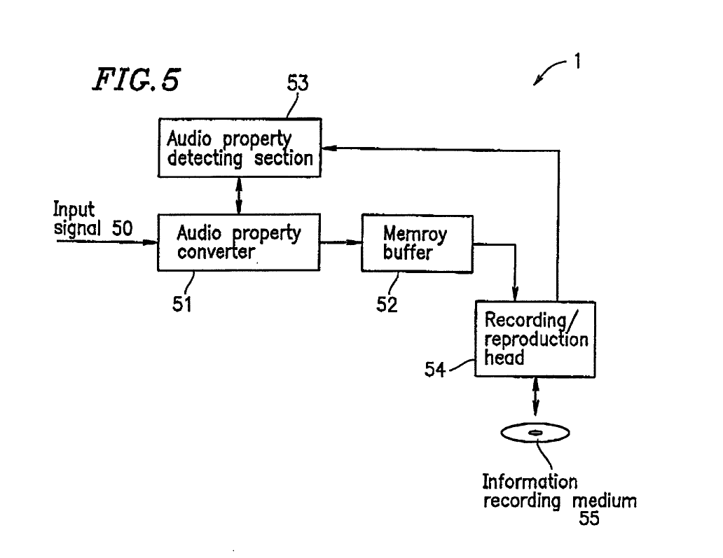

FIG. 5 shows a recording apparatus 1 according to embodiment 1 of the present invention. The recording apparatus 1 can record a plurality of audio information having a plurality of different audio properties. In embodiment 1, the recording apparatus 1 records intermission information as a part of a song at the tail of the song. That is, the recording apparatus 1 records intermission information so as to be adjacent to the tall of an audio content of the song. The recording apparatus 1 includes: an audio property converter 51; a memory buffer 52 for storing at least a portion of audio information; an audio property detecting section 53; and a recording/reproduction head 54 for recording audio information in an information recording medium, such as an optical head.

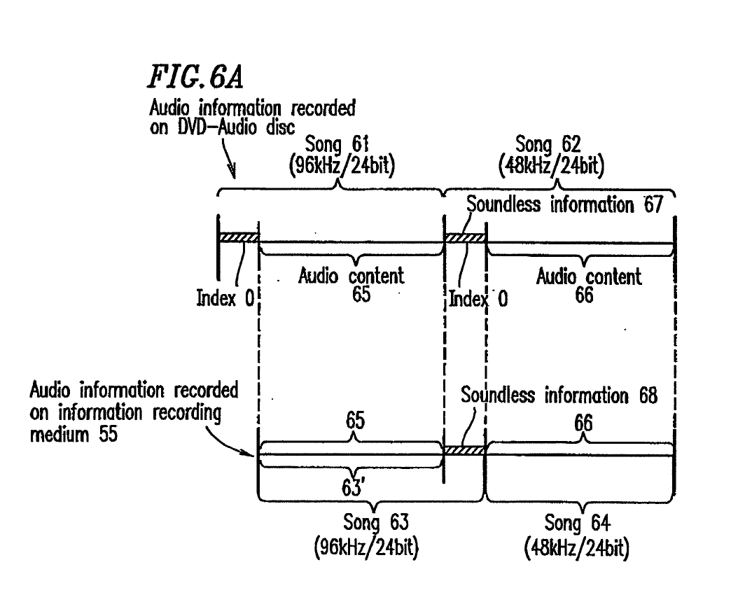

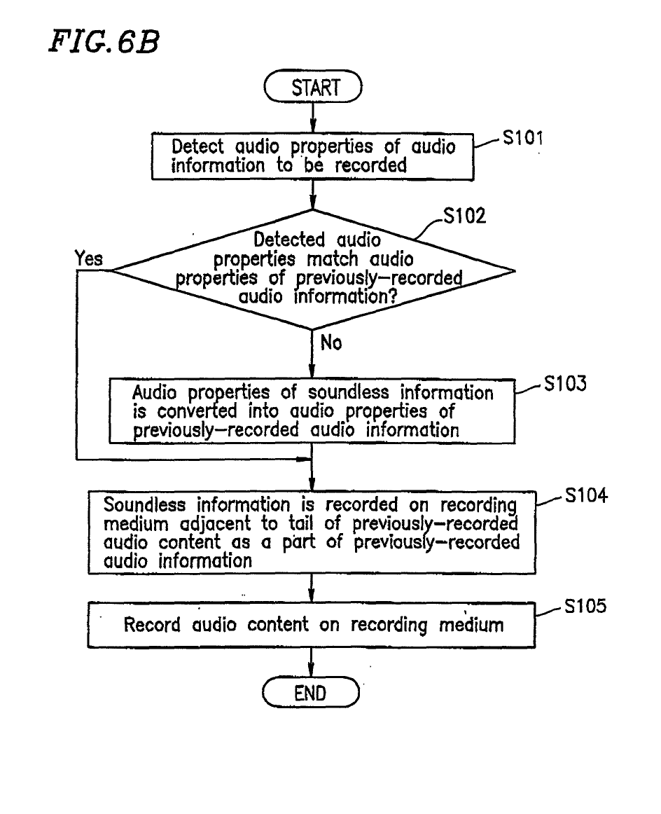

Referring to FIG. 6A in conjunction with FIG. 5, copying of songs by using the recording apparatus 1 is described. In the example illustrated in FIG. 6A, the recording apparatus 1 records a song 61 and a song 62 into an information recording medium 55 as a song 63 and a song 64. For example, the song 61 and the song 62 to be recorded are stored in a DVD-Audio disc. The information recording medium 55 is a rewritable or write once type information recording medium which can store ad plurality of songs having a plurality of different audio properties. When an audio content 65 included in audio information of the song 61 reproduced by a reproduction apparatus is input to the recording apparatus 1 as an input signal 50, the audio property detecting section 53 detects audio properties of the audio content 65 before the audio content 65 is output from the audio property converter 51. In this example, the audio property detecting section 53 detects audio properties of 96 kHz and 24 bit as the audio properties of a song 61. Thereafter, the audio content 65 is recorded in the information recording medium 55 by the recording/reproduction head 54.

Next, the song 62 is input into the recording apparatus 1. Referring to a flowchart shown in FIG. 6B in conjunction with FIGS. 5 and 6A, when soundless information 67 which is intermission information included in Index 0 of the song 62 is input into the recording apparatus 1, the audio property detecting section 53 detects audio properties of the soundless information 67 (Step S101) and then compares the detected audio properties of the soundless information 67 with the previously-detected audio properties of the audio content 65 (Step S102). During this detection/comparison operation, an audio content 66 included in the song 62 is temporally stored in the memory buffer 52. In this example, the audio property detecting section 53 detects audio properties of 48 kHz and 24 bit as the audio properties of the soundless information 67, and determines that the audio properties of the soundless information 67 are different from the previously-detected audio properties of the audio content 65. Based on the determination of the audio property detecting section 53, the audio property converter 51 converts the soundless information 67 into soundless information 68 which has the same audio properties as those of the audio content 65 (96 kHz and 24 bit) (Step S103). The recording/reproduction head 54 records the soundless information 68 as a part of the song 63 so as to be adjacent to the tail of the audio content 65 (Step S104). As a result, the song 63 includes the audio content 65 and the soundless information 68 which have the same audio properties. Next, an audio content 66 of the song 62 is recorded into the information recording medium 55 as the song 64 (Step S105). The song 64 is recorded into the information recording medium 55 such that the song 64 is reproduced immediately after a song 63.

Next, another example where soundless information 68 and an audio content 66 are recorded into an information recording medium 55, in which a song 63′ including an audio content 65 has been previously recorded, in an area immediately after the previously-recorded audio content 65 is described. In this example, the recording/reproduction head 54 reads the audio content 65 from the information recording medium 55, and the audio property detecting section 53 detects audio properties of the read audio content 65 (96 kHz and 24 bit). Then, as described above, when soundless information 67 included in Index 0 of the song 62 is input into the recording apparatus 1, the audio property detecting section 53 detects audio properties of the soundless information 67 and then compares the detected audio properties of the soundless information 67 with the previously-detected audio properties of the audio content 65. During this detection/comparison operation, an audio content 66 included in the song 62 is temporally stored in the memory buffer 52. In this example, the audio property detecting section 53 detects audio properties of 48 kHz and 24 bit as the audio properties of the soundless information 67, and determines that the audio properties of the soundless information 67 are different from the previously-detected audio properties of the audio content 65. Based on the determination of the audio property detecting section 53, the audio property converter 51 converts the soundless information 67 into soundless information 68 which has the same audio properties as those of the audio content 65 (96 kHz and 24 bit). The recording/reproduction head 54 records the soundless information 68 as apart of the song 63 so as to be adjacent to the tall of the audio content 65. As a result, the song 63 includes the audio content 66 and the soundless information 68 which have the same audio properties. Next, an audio content 66 of the song 62 is recorded into the information recording medium 55 as the song 64. The song 64 is recorded into the information recording medium 55 such that the song 64 is reproduced immediately after the song 63.

When the soundless information 67 and the audio content 65 have the same audio properties, the soundless information 67 is recorded without being converted in the information recording medium 55 as a part of the song 63 so as to be adjacent to the tail of the audio content 65. In this case, the song 63 includes the audio content 65 and the soundless information 67 which have the same audio properties.

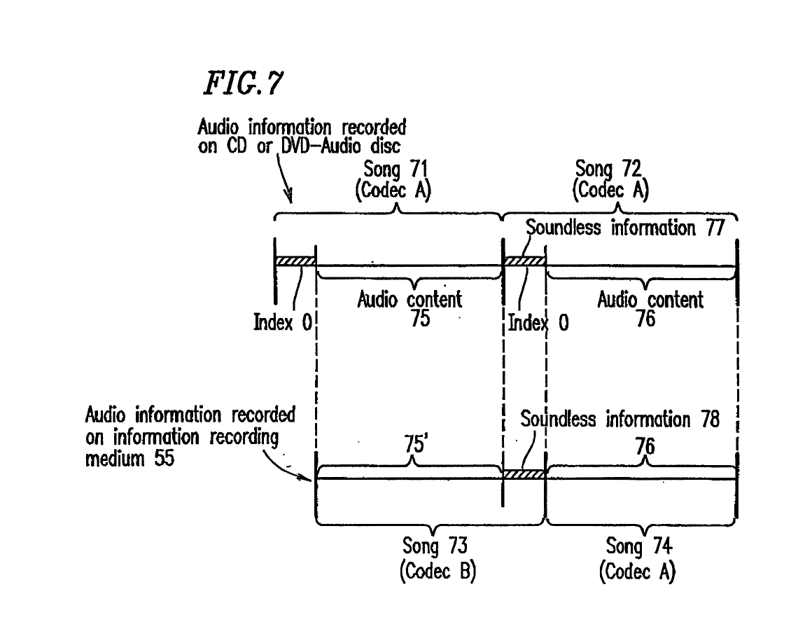

Next, an example of recording where songs are recorded in an information recording medium so as to have different audio properties is described with reference to FIG. 7 in conjunction with FIG. 5. In the example illustrated in FIG. 7, a song 71 and a song 72 recorded in a CD or a DVD-Audio disc have the same audio properties, but the song 71 and the song 72 are recorded in the information recording medium 55 as a song 73 and a song 74 which have different audio properties. The audio properties of the audio content 75 included in the song 71 which is input to the recording apparatus 1 are converted by the audio property converter 51 into different audio properties, where by an audio content 75′ is generated. The audio property detecting section 53 detects the audio properties of the audio content 75′ before the audio content 75′ is recorded in the information recording medium 55. For example, the audio property detecting section 53 detects that the audio content 75′ was compressed by a compression method called “Codec B”. Thereafter, when soundless information 77 included in Index 0 of the song 72 is input into the audio property converter 51, the audio property detecting section 53 detects that the soundless information 77 was compressed by a compression method called “Codec A”. Since the audio content 75′ and the soundless information 77 have different audio properties, the audio property converter 51 converts the soundless information 77 having the audio property of “Codec A” into soundless information 78 having the audio property of “Codec B” so as to conform to the audio content 75′. The recording/reproduction head 54 records the soundless information 78 in the information recording medium 55 as a part of the song 73 so as to be adjacent to the tail of the audio content 75′. As a result. the song 73 includes the audio content 751 and the soundless information 78 which have the same audio properties. Next, an audio content 76 of the song 72 is recorded into the information recording medium 55 as the song 74. The song 74 is recorded into the information recording medium 55 such that the song 74 is reproduced immediately after the song 73.

According to embodiment 1 of the present invention, the recording apparatus 1 does not need to newly generate intermission information for recording in the information recording medium 55 so as to be adjacent to the head or tail of an audio content. Furthermore, a single song can be prevented from mixedly including a plurality of different audio properties.

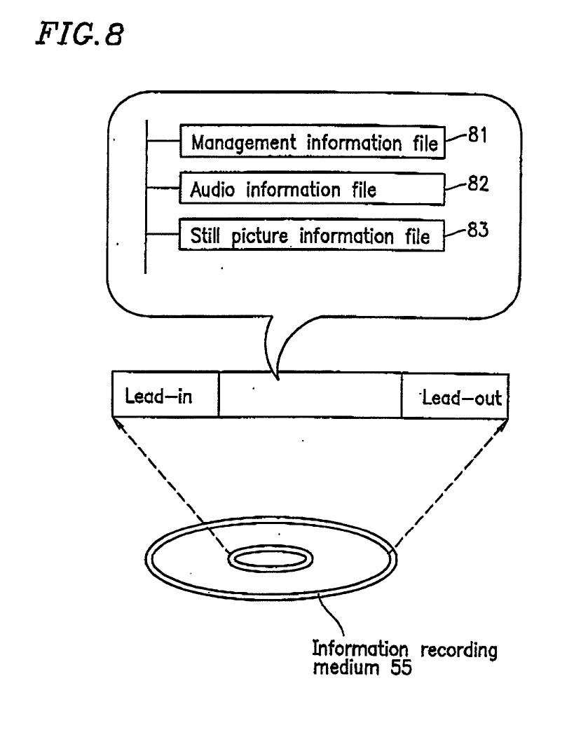

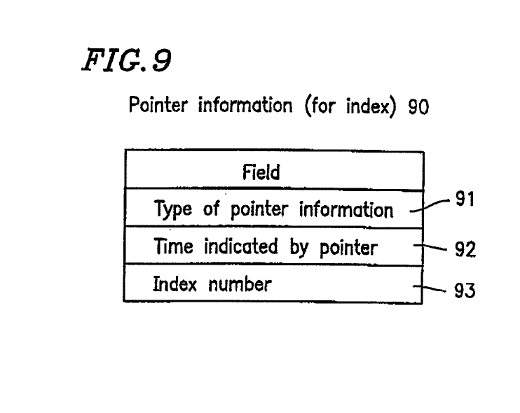

Next, an example where the information recording medium 55 is a DVD-RAM, DVD-RW, or DVD-R disc, and the recording apparatus 1 records audio information in the DVD-RAM, DVD-RW, or DVD-R disc is described in detail. As shown in FIG. 8, a DVD-RAM disc, a DVD-RW disc, and a DVD-R disc include an audio information file 82 for recording audio information, a still picture information file 83 for recording still picture information, and a management information file 81 for recording management information which is used for managing the audio information and the still picture information. The management information file 81 includes pointer:information 90 as shown in FIG. 9 which indicates the head of an index. The “index” is defined as one of the regions obtained by logically dividing an area occupied by a single song. The pointer information 90 includes a type 91 of pointer information, a time (time information) 92 indicated by the pointer, and an index number 93. According to embodiments of the present invention, at least a part of the pointer information 90 is changed or generated by the audio property converter 51 according to a transfer of intermission information or generation of intermission information.

As described above, in the case where intermission information is recorded as a part of a song, the intermission information is recorded within a single index. Pointer information 90 of the index in which the intermission information is recorded includes: an identifier indicating the index as the type 91 of pointer information; a reproduction end time of an audio content included in the song as the time (time information) 92 indicated by the pointer: and a value which is a previous index number plus 1 as the index number 93.

In embodiment 1, the recording apparatus 1 includes the audio property detecting section 53 for detecting audio properties. However, if the recording apparatus 1 can read a management information file 81 of audio information to be recorded by the recording apparatus 1, it is possible to identify audio properties of the audio information to be recorded from audio properties included in the management information file 81. Thus, in such a case, the audio property detecting section 53 may be omitted.

(Embodiment 2)

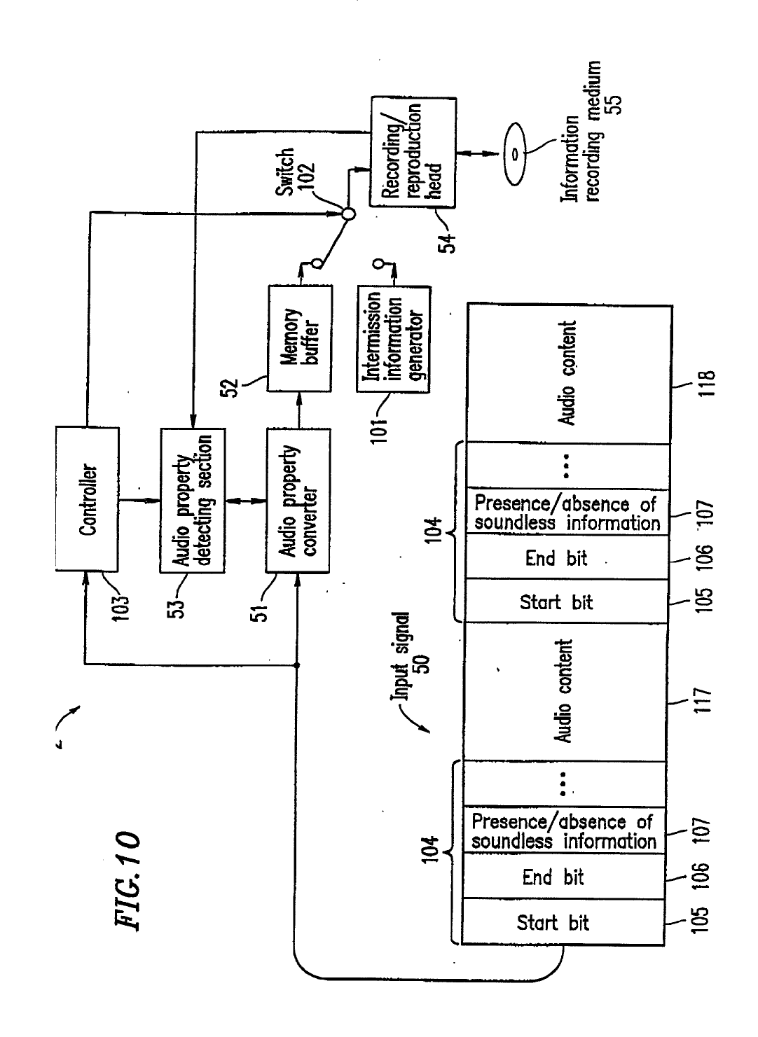

FIG. 10 shows a recording apparatus 2 according to the present invention. The recording apparatus 2 can record a plurality of audio information having a plurality of different audio properties. In embodiment 2, the recording apparatus 2 newly generates intermission information and records the generated intermission information in an information recording medium 55. The recording apparatus 2 includes: an audio property converter 51; a memory buffer 52; an audio property detecting section 53: recording/reproduction head 54; an intermission information generator 101; a switch 102; and a controller 103 for controlling at least the audio property detecting section 53 and the switch 102.

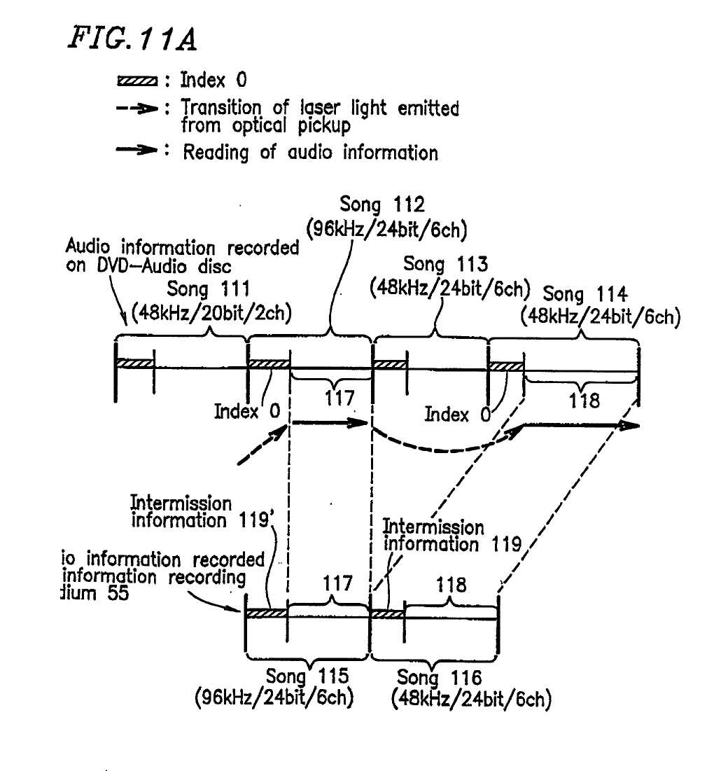

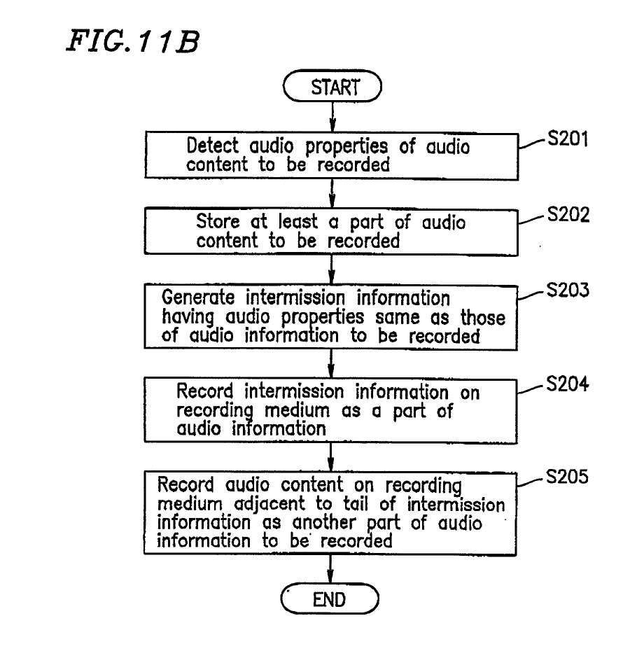

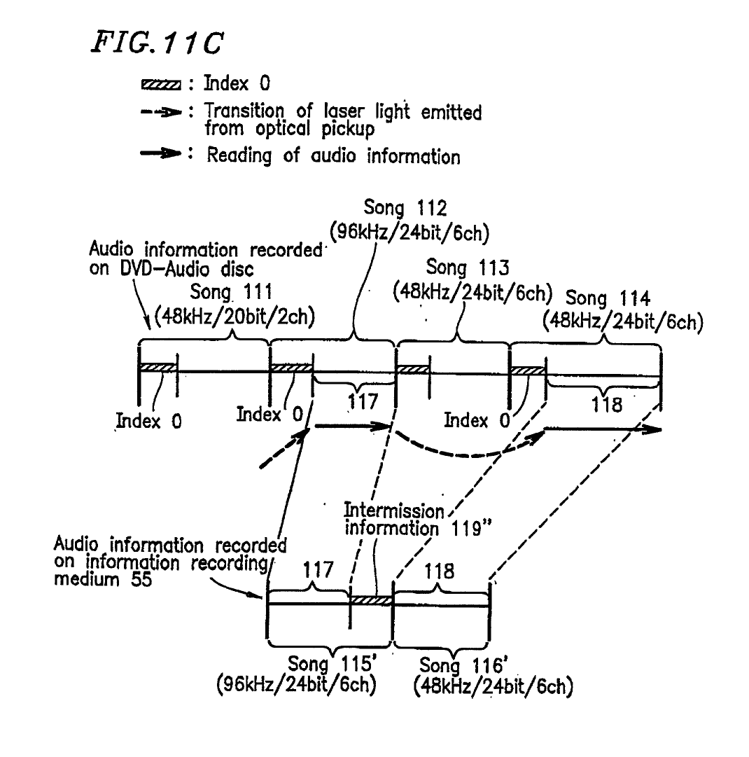

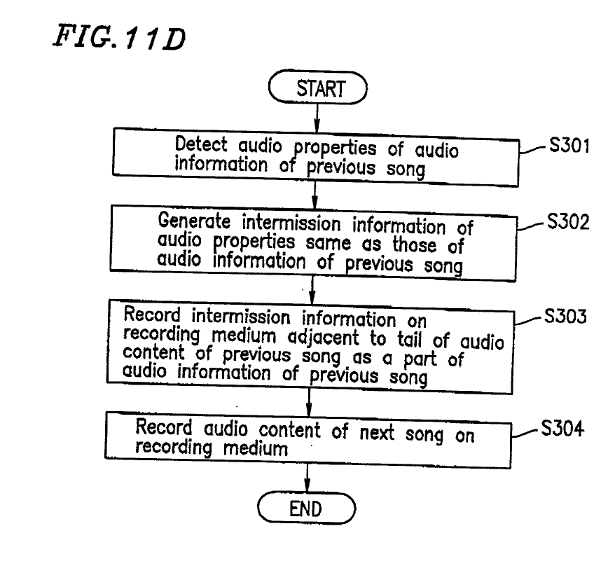

With reference to FIG. 10 and FIGS. 11A through 11D, an example of automatic recording of the recording apparatus 2 is described. In this example, after a reproduction apparatus starts to read audio information from a CD or a DVD-Audio disc, the recording apparatus 2 automatically starts to record the audio information read by the reproduction apparatus into an information recording medium 55.

For example, as shown in FIG. 11A, a song 112 and a song 114 are recorded in the information recording medium 55 as a song 115 and a song 116, respectively. When the song 112 and the song 114 are reproduced, in many reproduction apparatuses, only audio contents 117 and 118 are reproduced while Index 0 of the song 112 and Index 0 of the song 114 are skipped. Accordingly, after the audio content 117 of the song 112 is recorded in the information recording medium 55 as the song 115, the audio content 118 of the song 114 is input to the recording apparatus 2. The audio property detecting section 53 detects audio properties of the audio content 118, and the audio content 118 is buffered in the memory buffer 52 (Steps S201 and S202 in FIG. 11B). While the audio content 115 is buffered in the memory buffer 52, the intermission information generator 101 generates intermission information 119 having the same audio properties as the detected audio properties of the audio content 118 (Step S203). The controller 103 controls the switch 102 so as to connect to the intermission information generator 101 so that the intermission information 119 is recorded in the information recording medium 55 as a part of the song 116 (Step S204). After the recording of the intermission information 119 is completed, the controller 103 controls the switch 102 so as to connect to the memory buffer 52 so that the audio content 118, at least a part of which is buffered in the memory buffer 52, is recorded in the information recording medium 55 so as to be adjacent to the tail of the intermission information 119 (Step 5205). The song 116 is recorded into the information recording medium 55 such that the song 116 is reproduced immediately after the song 115. As shown in FIG. 10, an input signal 50 supplied to the recording apparatus 2 includes the audio contents 117 and 118 of the songs 112 and 114, and control information 104 for the audio contents 117 and 118. The control information 104 includes a start bit 105, an end bit 106, presence/absence 107 of soundless information, etc., for each of the audio contents 117 and 118. The controller 103 determines from the start bit 105 and the end bit 106 the timing at which the audio property detecting section 53 detects audio properties and the timing of turning the switch 102, and gives these determined timings to the audio property detecting section 53 and the switch 102, respectively, such that each of the audio property detecting section 53 and the switch 102 operates at the optimum timing.

In this way, the intermission information 119 and the audio content 118 are recorded in the information recording medium 55 so as to generate audio information (i.e., song 116) where the newly-generated intermission information 119 is adjacent to the audio content 118 as shown in FIG. 11A.

The intermission information in embodiment 2, e.g., the intermission information 119, may be soundless information.

It should be noted that intermission information 119′ may be recorded at the head of the song 115 similarly to the intermission information 119 (see FIG. 11A). The intermission information 119′ has the sane audio properties as those of the audio content 117.

When the intermission information 119 is recorded at the head of the song 116, the intermission information 119 is recorded within a single index. In this case, the pointer information (see FIG. 9) of the index in which the intermission information 119 is stored includes: an identifier indicating the index as the type 91 of pointer information; a reproduction start time of the intermission information 119 as the time (time information) 92 Indicated by the pointer; and value “0” as the index number 93.

In the above example illustrated in FIGS. 11A and 11B, intermission information is recorded at the head of a song. Next, an example where intermission information is recorded at the tail of a song is described with reference to FIGS. 11C and 11D in conjunction with FIG. 10. In the example illustrated in FIG. 11C, intermission information 119″ is recorded so as to be adjacent to the tail of an audio content 117 of a previous song (song 115′) as shown in FIG. 11C.

In the first place, audio properties of the audio content 117 input into the recording apparatus 2 are detected by the audio property detecting section 53 (Step S301). The switch 102 is connected to the memory buffer 52 so that the audio content 117 is recorded in the information recording medium 55. Thereafter, the intermission information generator 101 generates intermission information 119″ having the same audio properties as the detected audio properties of the audio content 117 (Step S302). The switch 102 is connected to the intermission information generator 101 so that the intermission information 119″ is recorded in the information recording medium 55 so as to be adjacent to the tall of the previously-recorded audio content 117 (Step S303). Even if an audio content 118 of the song 114 is input into the recording apparatus 2 during the recording of the intermission information 119″, the audio content 118 is buffered in the memory buffer 52 until the recording of the intermission information 119″ is completed. After the recording of the intermission information 119″ is completed, the switch 102 is connected to the memory buffer 52 so that the audio content 118 buffered in the memory buffer 52 is recorded in the information recording medium 55 as a song 116′ (Step S304). The song 116′ can be recorded in the information recording medium 55 such that the song 116′ is reproduced immediately after the song 115′.

The song 115′ including the audio content 117 may be previously recorded in the information recording medium 55.

Even when a recording operation ends at the end of the recording of the song 115′ so that the song 116′ is not recorded in the information recording medium 55 (e.g., when only the song 115′ is recorded in the information recording medium 55), the intermission information 119″ may be recorded at the tail of the song 115′.

As described above, the intermission information 119″ is recorded so as to be adjacent to the tail of the audio content 117 which has been previously recorded in the information recording medium 55, whereby audio information including the audio content 117 and the intermission information 119″ (i.e., song 115′) is recorded in the information recording medium 55. The intermission information 119 ″ may be soundless information. The song 115′ includes the same pointer information as that described in embodiment 1.

According to embodiment 2, even if any type of reproduction apparatus is used, intermission information which indicates an interval between songs as well as audio contents of songs can be recorded in the information recording medium 55.

In embodiment 2, the recording apparatus 2 includes the audio property. detecting section 53 for detecting audio properties. However, if the recording apparatus 2 can read a management information file 81 (FIG. 8) of audio information to be recorded by the recording apparatus 2, it is possible to identify audio properties of the audio information to be recorded from audio properties included in the management information file 81. Thus, in such a case, the audio property detecting section 53 may be omitted.

(Embodiment 3)

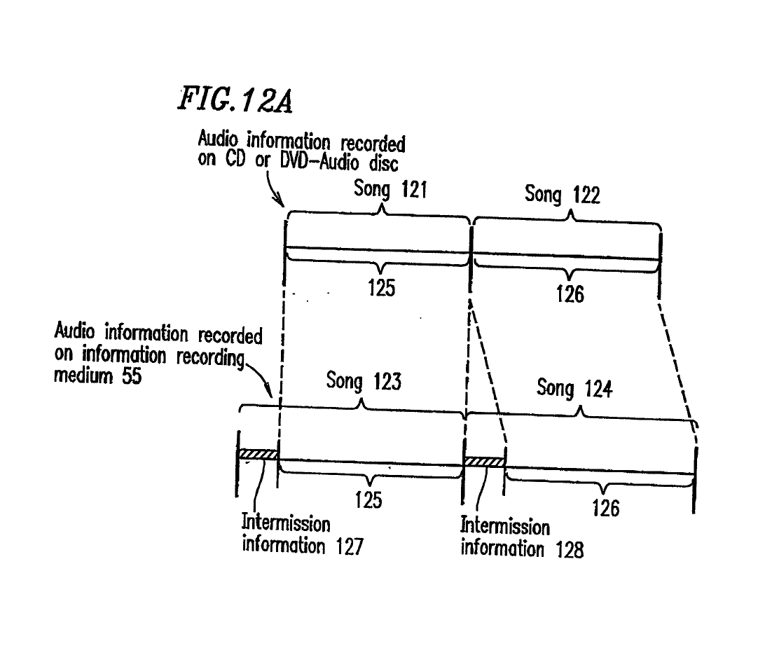

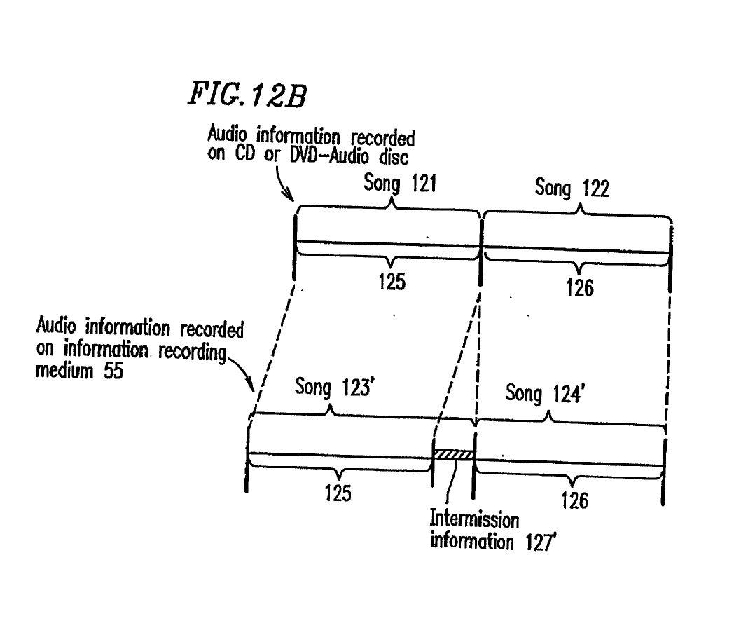

In embodiment 3, recording of a song in which Index 0 is not defined into an information recording medium 55 is described. As shown in FIG. 12A, in each of songs 121 and 122 stored in a CD or a DVD-Audio disc, Index 0 is not defined.

First, an example where intermission information 127 and 128 are inserted at the heads of songs 123 and 124, respectively, is described with reference to FIG. 12A in conjunction with FIG. 10. For example, the recording apparatus 2 of FIG. 10 records the songs 121 and 122 read out from the CD or DVD-Audio disc into the information recording medium 55 as the songs 123 and 124, respectively, as shown in FIG. 12A.

After recording of an audio content 125 of the song 121 into the information recording medium 55 is completed, an audio content 126 of the song 122 is input into the recording apparatus 2, and the audio property detecting section 53 detects audio properties of the audio content 126. Then, at least a portion of the audio content 126 is buffered in the memory buffer 52. While the audio content 126 is buffered in the memory buffer 52, the intermission information generator 101 generates intermission information 128 having the same audio properties as the detected audio properties of the audio content 126. Then, the switch 102 is connected to the intermission information generator 101 so that the intermission information 128 is recorded in the information recording medium 55 as a part of the song 124, After the recording of the intermission information 128 is completed, the switch 102 is connected to the memory buffer 52 so that the buffered portion of the audio content 126 and the remainder of the audio content 126 are recorded subsequent to the intermission information 128 in the information recording medium 55. As a result, audio information including the intermission information 128 and the audio content 126 (i. e. song 124) is obtained in the information recording medium 55. The song 124 is recorded Into the information recording medium 55 such that the song 124 is reproduced immediately after the song 123. The intermission information 128 may be soundless information. The song 124 includes the same pointer information as that described in an example of embodiment 2 where intermission information is recorded at the head of a song.

It should be noted that intermission information 127 may be recorded at the head of the song 123 similarly to the intermission information 128. The intermission information 127 has the same audio properties as those of the audio content 125.

Next, an example where intermission information is recorded so as to be adjacent to the tail of an audio content is described with reference to FIG. 12B in conjunction with FIG. 10. In the example illustrated in FIG. 12B, intermission information 127′ is recorded at the tail of a song 123′.

In the first place, audio properties of the audio content 125 input Into the recording apparatus 2 are detected by the audio property detecting section 53. The switch 102 is connected to the memory buffer 52 so that the audio content 125 is recorded in the information recording medium 55. Thereafter, the intermission information generator 101 generates intermission information 127′ having the same audio properties as the detected audio properties of the audio content 125. Then, the switch 102 is connected to the intermission information generator 101 so that the intermission information 127′ is recorded In the information recording medium 55 so as to be adjacent to the tail of the audio content 125. Even if an audio content 126 of the song 122 is input into the recording apparatus 2 during the recording of the intermission information 127′, the audio content 126 is buffered in the memory buffer 52 until the recording of the intermission information 127′ is completed. After the recording of the intermission information 127′ is completed, the switch 102 is connected to the memory buffer 52 so that the audio content 126 buffered in the memory buffer 52 is recorded in the information recording medium 55 as a song 124′ so as to be adjacent to the tail of the intermission information 127′. The song 124′ can be recorded in the information recording medium 55 such that the song 124′ is reproduced immediately after the song 123′. The song 123′ includes the same pointer information as that described in embodiment 1 (see FIG. 9).

According to embodiment 3, even when songs to be recorded do not have intermission information therebetween, intermission information can be newly generated and recorded in an information recording medium 55 together with audio contents of the songs.

In embodiment 3, the recording apparatus 2 includes the audio property detecting section 53 for detecting audio properties. However, if the recording apparatus 2 can read a management information file 81 (FIG. 8) of audio information to be recorded by the recording apparatus 2, it is possible to identify audio properties of the audio information to be recorded from audio properties included in the management information file 81. Thus, in such a case, the audio property detecting section 53 may be omitted.

According to the present invention, the information recording medium 55 is not limited to an optical disc medium, but may be any type of recording medium so long as it can store a plurality of songs having a plurality of different audio properties. For example, the information recording medium 55 may be a tape-shaped recording medium, a hard disk, a semiconductor memory, or the like.

According to the present invention, there is provided a recording apparatus by which audio properties of intermission information adjacent to the head of an audio content to be recorded are converted to the same audio properties as those of previously-recorded audio information in an information recording medium, and the intermission information including the converted audio properties is recorded in the information recording medium as a part of the previously-recorded audio information so as to be adjacent to an audio content included in the previously-recorded audio information. The resultant audio information in the information recording medium includes the audio content and the intermission information which have the same audio properties. Thus, audio information recorded in an information recording medium by using the recording apparatus of the present invention can be appropriately reproduced without causing a mute period or noise during the reproduction thereof. Further, in an information recording medium storing audio contents recorded by the recording apparatus of the present invention, even when a plurality of audio contents having different audio properties are serially reproduced, a sufficient time is secured for a reproduction apparatus to change Its reproduction conditions so as to follow a change of audio properties during reproduction of the audio contents. Thus, the audio contents can be appropriately reproduced without causing a mute period or noise during the reproduction of a beginning portion of each audio content.

According to the present invention, there is provided a recording apparatus by which intermission information having the same audio properties as those of an audio content to be recorded is newly generated and recorded in an information recording medium as a part of newly-recorded audio information, and the audio content to be recorded is recorded as another part of the newly-recorded audio information so as to be adjacent to the tail of the newly-generated intermission information. Thus, even when intermission information is not externally supplied to the recording apparatus of the present invention, the recording apparatus of the present invention can newly generate intermission information and record the generated intermission information between audio contents. In an information recording medium storing audio contents recorded by the recording apparatus of the present invention, even when a plurality of audio contents having different audio properties are serially reproduced, a sufficient time is secured for a reproduction apparatus to change its reproduction conditions so as to follow a change of audio properties during reproduction of the audio contents. Thus, the audio contents can be appropriately reproduced without causing a mute period or noise during the reproduction of a beginning portion of each audio content. As described above, according to the present invention, even when intermission information included In a song to be copied is not input into a recording apparatus, intermission information can be newly-generated and recorded between copied audio contents. According to the present invention, when audio contents having a plurality of different audio contents are recorded in an information recording medium, audio properties of an audio content to be recorded are detected, and intermission information having the same audio properties as those of the audio content to be recorded among various audio properties compatible with the information recording medium is generated. The generated intermission information is recorded in the information recording medium so as to be adjacent to the head of the audio content to be recorded.

According to the present invention, there is provided a recording apparatus by which intermission information having the same audio properties as those of an audio content included in previously-recorded audio information in an information recording medium is newly generated and recorded in the information recording medium as a part of the previously-recorded audio information so as to be adjacent to the tail of the audio content included in the previously-recorded audio information, and then, further audio content is recorded in the information recording medium as further audio information. Thus, even when intermission information Is not externally supplied to the recording apparatus of the present invention, the recording apparatus of the present invention can newly generate intermission information and record the generated intermission information between audio contents. In an information recording medium storing audio contents recorded by the recording apparatus of the present invention, even when a plurality of audio contents having different audio properties are serially reproduced, a sufficient time is secured for a reproduction apparatus to change its reproduction conditions so as to follow a change of audio properties during reproduction of the audio contents. Thus, the audio contents can be appropriately reproduced without causing a mute period or noise during the reproduction of a beginning portion of each audio content. As described above, according to the present invention, even when intermission information included in a song to be copied is not input into a recording apparatus, intermission information can be newly-generated and recorded between copied audio contents.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A recording apparatus for recording a first audio content in an information recording medium which can store a plurality of audio contents having a plurality of different audio properties, the first audio content being included in first audio information together with soundless information adjacent to a head of the first audio content, and the information recording medium containing second audio information including a second audio content,
wherein the recording apparatus includes:
a detecting section for detecting audio properties of the first audio information and determining whether or not the detected audio properties of the first audio information are identical to audio properties of the second audio information;
a conversion section for converting audio properties of the soundless information into the same audio properties as the audio properties of the second audio information when the detected audio properties of the first audio information are not identical to the audio properties of the second audio information; and
a recording section for recording the soundless information in the information recording medium as a part of the second audio information so as to be adjacent to a tail of the second audio content, and recording the first audio content in the information recording medium.

2. A recording apparatus according to claim 1, further comprising a memory buffer for storing at least a portion of the first audio content.

3. A recording apparatus according to claim 1, wherein the audio properties include at least one of a sampling frequency, a number of quantization bits, a number of channels, and a coding method.

4. A recording apparatus according to claim 1, wherein the information recording medium lo a rewritable or write once type information recording medium.

5. A recording apparatus for recording an audio content in an information recording medium which can store a plurality of audio contents having a plurality of different audio properties,
wherein the recording apparatus includes:
a detecting section for detecting audio properties of the audio content;
a memory buffer for storing at least a portion of the audio content;
a generating section for generating intermission information having the same audio properties as the detected audio properties of the audio content; and
a recording section for recording the intermission information in the information recording medium as a part of audio information, and recording the audio content in the information recording medium as another part of the audio information so as to be adjacent to the tail of the intermission information.

6. A recording apparatus according to claim 5, wherein the intermission information is soundless information.

7. A recording apparatus according to claim 5, wherein the audio properties include at least one of a sampling frequency, a number of quantization bits, a number of channels, and a coding method.

8. A recording apparatus according to claim 5, wherein the information recording medium is a rewritable or write once type information recording medium.

9. A recording apparatus for recording a first audio content immediately after second audio information including a second audio content in an information recording medium which can store a plurality of audio contents having a plurality of different audio properties,
wherein the recording apparatus includes:
a detecting section for detecting audio properties of the second audio information;
a generating section for generating intermission information having the same audio properties as the detected audio properties of the second audio information; and
a recording section for recording the intermission information in the information recording medium as a part of the second audio information so as to be adjacent to a tail of the second audio content, and recording the first audio content in the information recording medium.

10. A recording apparatus according to claim 9, wherein the intermission information is soundless information.

11. A recording apparatus according to claim 9, further comprising a memory buffer for storing at least a portion of the first audio content.

12. A recording apparatus according to claim 9, wherein the audio properties include at least one of a sampling frequency, a number of quantization bits, a number of channels, and a coding method.

13. A recording apparatus according to claim 9, wherein the information recording medium is a rewritable or write once type information recording medium.

14. A recording method for recording a first audio content in an information recording medium which can store a plurality of audio contents having a plurality of different audio properties, the first audio content being included in first audio information together with soundless information adjacent to a head of the first audio content, and the information recording medium containing second audio information including a second audio content,
wherein the recording method includes steps of:
detecting audio properties of the first audio information and determining whether or not the detected audio properties of the first audio information are identical to audio properties of the second audio information;
converting audio properties of the soundless information into the same audio properties as the audio properties of the second audio information when the detected audio properties of the first audio information are not identical to the audio properties of the second audio information; and
recording the soundless information in the information recording medium as a part of the second audio information so as to be adjacent to a tall of the second audio content, and recording the first audio content in the information recording medium.

15. A recording method according to claim 14, further comprising a step of storing at least a portion of the first audio content.

16. A recording method according to claim 14, wherein the audio properties include at least one of a sampling frequency, a number of quantization bits, a number of channels, and a coding method.

17. A recording method according to claim 14, wherein the information recording medium is a rewritable or write once type information recording medium.

18. A recording method for recording an audio content in an information recording medium which can store a plurality of audio contents having a plurality of different audio properties,
wherein the recording method includes steps of:
detecting audio properties of the audio content;
storing at least a portion of the audio content;
generating intermission information having the same audio properties as the detected audio properties of the audio content; and
recording the intermission information in the information recording medium as a part of audio information, and recording the audio content in the information recording medium as another part of the audio information so as to be adjacent to the tail of the intermission information.

19. A recording method according to claim 18, wherein the intermission information is soundless information.

20. A recording method according to claim 18, wherein the audio properties include at least one of a sampling frequency, a number of quantization bits, a number of channels, and a coding method.

21. A recording method according to claim 18, wherein the information recording medium is a rewritable or write once type information recording medium.

22. A recording method for recording a first audio content immediately after second audio information including a second audio content in an information recording medium which can store a plurality of audio contents having a plurality of different audio properties,
wherein the recording method includes steps of:
detecting audio properties of the second audio information;
generating intermission information having the same audio properties as the detected audio properties of the second audio information; and
recording the intermission information in the information recording medium as a part of the second audio information so as to be adjacent to a tail of the second audio content, and recording the first audio content in the information recording medium.

23. A recording method according to claim 22, wherein the intermission information is soundless information.

24. A recording method according to claim 22, further comprising a step of storing at least a portion of the first audio content.

25. A recording method according to claim 22, wherein the audio properties include at least one of a sampling frequency, a number of quantization bits, a number of channels, and a coding method.

26. A recording method according to claim 22, wherein the information recording medium is a rewritable or write once type information recording medium.
